(19) United States
(12) Patent Application Publication
(10) Pub. No.: US 2023/0391187 A1
(43) Pub. Date: Dec. 7, 2023

(54) Fluid Barriers for a Vehicle Fluid Delivery System

(71) Applicant: Castrol Limited, Pangbourne, Reading (GB)

(72) Inventors: Ross Alexander Dewhurst, Middlesex (GB); Oliver Paul Taylor

(21) Appl. No.: 18/034,673

(22) PCT Filed: Oct. 29, 2021
(86) PCT No.: PCT/IB2021/060065

§ 371 Date: Apr. 28, 2023

(30) Foreign Application Priority Data
Oct. 30, 2020 (GB) 2017242.5

(51) Int. Cl. B60K 15/073; B60K 15/04

(52) U.S. Cl. CPC B60K 15/073; B60K 15/04; B60K 2015/0458

(57) ABSTRACT

The present disclosure provides a vehicle fluid delivery system comprising (a) a housing defining a first cavity, wherein the housing includes a first side and a second side opposite the first side, the first side and the second side being separated by a continuous side wall extending around their peripheries, and wherein the housing is adapted to be removable from a vehicle, (b) a fluid reservoir positioned in the first cavity of the housing, (c) a fluid port coupling disposed on the first side of the housing and providing fluid access to the fluid reservoir, and (d) a fluid barrier external to and contiguous with the side wall.

### BACKGROUND

Many vehicle engines use one or more fluids for their operation. Such fluids are often liquids. For example, internal combustion engines use liquid lubricating oil compositions. As another example, electric engines use heat exchange liquids for example to cool the engine, to heat the engine or to cool and heat the engine during different operating conditions. Such fluids are generally held in reservoirs associated with the engine and may require periodic replacement.

Conventional periodic replacement of engine lubricating oil composition in a vehicle engine usually involves draining the composition from the engine sump. The process may also involve removing and replacing the engine oil filter. Such a procedure usually requires access to the engine sump drain plug and oil filter from the underside of the engine, may require the use of hand tools and usually requires a suitable collection method for the drained lubricating oil composition. Due to the inherent drawbacks of replacing fluid in a vehicle using traditional methods, a quick-change system may be desirable. An example quick-change system may include a fluid reservoir that is configured to hold a liquid, such as a lubricating oil. The fluid reservoir may be removably positioned in a cavity of a housing.

When in use, impact damage to such a quick-change system in a vehicle engine may occur as result of a high speed collision where very high energies and forces are imparted onto the engine bay components causing damage to the majority of components. The fluid in the quick-change system may be hazardous, for example flammable, and the release of the fluid may consequently cause danger to operators or equipment. Passenger cars powered by internal combustion engines in particular have several fluid systems incorporating pipes and tanks and are also involved in vehicle traffic collisions. The release of combustible fluids after damage to the fluid systems may cause a post collision fire. The importance of fire prevention in passenger cars is even more important in modern hybrid powertrains where high voltages are a potential ignition source and battery packs may suffer from fires.

### OVERVIEW

Disclosed herein are vehicle fluid delivery systems with fluid barriers and methods for use. Beneficially, the fluid barriers of the vehicle fluid delivery systems described herein provide secondary containment to help mitigate or prevent loss of liquid from a vehicle fluid delivery system or to slow the release of the liquid in a controlled direction.

Thus, in a first aspect, the present disclosure provides a vehicle fluid delivery system comprising (a) a housing defining a first cavity, wherein the housing includes a first side and a second side opposite the first side, the first side and the second side being separated by a continuous side wall extending around their peripheries, and wherein the housing is adapted to be removable from a vehicle, (b) a fluid reservoir positioned in the first cavity of the housing, (c) a fluid port coupling disposed on the first side of the housing and providing fluid access to the fluid reservoir, and (d) a fluid barrier external to and contiguous with the side wall.

In one embodiment, the fluid barrier extends across the first side of the housing.

In another embodiment, the fluid barrier extends between the first side and the second side of the housing.

In another embodiment, the fluid barrier forms a second cavity in which the housing is positioned.

In another embodiment, the fluid barrier is a shield.

In another embodiment, the fluid barrier comprises a ductile elastomer.

In another embodiment, the material forming the fluid barrier has a lower elastic modulus than the housing.

In another embodiment, the material forming the fluid barrier has a higher fracture toughness than the housing.

In another embodiment, the material forming the fluid barrier has a higher strain value at its yield point on a stress-strain curve than the housing.

In another embodiment, the housing is load-bearing and the fluid barrier is non-load-bearing.

In another embodiment, the housing comprises a flexible glass fibre bonded with a flexible epoxy.

In another embodiment, the fluid barrier comprises an absorbent material.

In another embodiment, the fluid barrier further comprises an absorbent material positioned in a gap between an outer surface of the housing and an inner surface of the fluid barrier.

In another embodiment, the absorbent material comprises a flexible foam or a fibrous matting.

In another embodiment, the absorbent material comprises an open-cell foam having a seal adjacent the inner surface of the fluid barrier.

In another embodiment, vehicle fluid delivery system further comprises (i) an oil filter disposed in the first cavity of the housing, and (ii) a second fluid port coupling disposed on the first side of the housing, wherein the second fluid port coupling includes an inlet to the oil filter and an outlet.

In another embodiment, the fluid barrier includes a through-hole through which the fluid port coupling is disposed.

In another embodiment, the fluid reservoir includes a fluid positioned therein, and where the fluid comprises an engine oil, a gear oil or a heat exchange fluid for an electric motor.

In a second aspect, the present disclosure provides a vehicle comprising (a) the vehicle fluid delivery system of any of the embodiments of the first aspect, and (b) a fluid system of the vehicle in fluid communication with the housing.

In one embodiment, the fluid system delivers a lubricating oil to an engine of the vehicle.

In a third aspect, the present disclosure provides an apparatus comprising (a) the vehicle fluid delivery system of any of the embodiments of the first aspect, and (b) a fluid system of the apparatus in fluid communication with the housing.

In a fourth aspect, the present disclosure provides a method of retaining a fluid discharged from the vehicle fluid delivery system of any of the embodiments of the first aspect during an impact, the method comprising: (a) before an impact occurs: (i) providing a fluid barrier, and (ii) associating the housing with the fluid barrier, and (b) during an impact: (i) retaining, by the fluid barrier, the fluid discharged from the fluid reservoir.

In one embodiment, the method further comprises the steps of when the vehicle comes to rest: releasing the fluid from the fluid barrier under gravity.

In another embodiment, the method further comprises the steps of removing the housing and fluid barrier together from the vehicle.

These as well as other aspects, advantages, and alternatives, will become apparent to those of ordinary skill in the art by reading the following detailed description.

### BRIEF DESCRIPTION OF THE DRAWINGS

Example embodiments are described herein with reference to the drawings, in which:

FIG. 1 is a side cross-section view of a vehicle fluid delivery system in fluid communication with a fluid system of the vehicle, in accordance with example embodiments;

FIG. 2 is a perspective view of the fluid barrier of the vehicle fluid delivery system of FIG. 1, in accordance with example embodiments;

FIG. 3A is a perspective view of an example fluid barrier, in accordance with example embodiments;

FIG. 3B is a perspective view of the example fluid barrier of FIG. 3A with the housing of the vehicle fluid delivery system of FIG. 1 positioned therein, in accordance with example embodiments;

FIG. 4 is a perspective view of an example device, in accordance with example embodiments; and

FIG. 5 is a side cross-section view of the device of FIG. 4, in accordance with example embodiments.

FIG. 6 is a flow chart of functions to carry out a method, in accordance with example embodiments.

### DETAILED DESCRIPTION

Example and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

As used herein, with respect to measurements, “about” means +/−5%.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment” or “one example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Embodiments of the present disclosure may provide a fluid system for supplying a fluid, in particular a lubricating fluid, to a fluid circulation system of an engine.

The fluid system described herein may be suitable for supplying a fluid to an engine having, or having associated with it, a fluid circulation system. The fluid circulation system or subsystems may be configured to circulate fluid around a particular area of the engine or, where the engine is a vehicle engine, an ancillary area of a vehicle.

Embodiments of the present disclosure may provide a fluid delivery system arranged to be associated with an engine, such as the engine of a vehicle. The vehicle fluid delivery system may include one or more valves for controlling the supply of its fluid to a fluid circulation system to which it is arranged to be fluidly coupled. A controller may be provided to control operation of the valves, for example by controlling the degree to which each valve is opened or closed, to control the rate or amount of fluid provided to the fluid circulation system. The controller may control the valves in accordance with a control regimen. Such a control regimen may be provided by an operational controller such as an engine control system, or it may be pre-programmed into the controller or supplied to the controller at a user interface. The control regime may be selected or modified based on a measurement of a property of one or more of the fluids, such as a measure of viscosity, density, temperature, cleanliness or chemical composition.

The vehicle fluid delivery system may be configured to store identification data indicating, for example, a serial number, manufacturer details, service history data, service regime data, one or more property of one or more of the fluids, the vehicle with which the vehicle fluid delivery system is designed to be used, container history data, engine history data of an engine with which the vehicle fluid delivery system has been used, and so on, and may be configured to communicate the identification data to the engine control device. The controller may be configured to select, or update, a service interval or control regime based on fluid-quality data provided by one or more sensors located in the engine or the vehicle fluid delivery system or on data provided from elsewhere.

While aspects of the present disclosure have been described in relation to vehicle engines and examples of the invention described the use of engine lubricating oil compositions, it is envisaged that features of the invention could find other applications.

For example, a fluid delivery system according to an aspect of the present disclosure could be used in relation to a wide range of apparatus or equipment. For example, the vehicle fluid delivery system could find application in relation to various static and movable machines, for example industrial machines such as a lathe, or manufacture and assembly equipment, to an engine, or to a vehicle, such as a passenger vehicle, to a vehicle other than a passenger vehicle, for example, an off-road vehicle (such as earth moving equipment or agricultural machinery) or a heavy duty vehicle (such as a truck). As another possibility, the vehicle fluid delivery system may be configured to supply fluid, during operation, to a fluid circulation system associated with an engine other than a vehicle engine or to a reverse engine or generator or a turbine such as a wind turbine, for example, a coolant or hydraulic fluid.

Examples of a fluid delivery system of an aspect of the present disclosure could thus be used to supply lubricant composition to a region of the apparatus or equipment, for example to a region including one or more moving parts, for example a gearbox. In an example of an aspect of the present disclosure there is provided a fluid delivery system for a wind turbine, for example to provide lubricating composition to one or more parts of the wind turbine apparatus.

The vehicle fluid delivery system may supply a lubricant composition to the apparatus, or may supply fluid other than lubricant to the apparatus. For example, the fluid may comprise a fuel composition, for example gasoline or diesel. The fluid reservoir of an aspect of the present disclosure may be for supply of the fluid for example to the fuel supply system of the apparatus. For example, the fluid reservoir may supply fuel to a vehicle, or tool, for example to a car, motorcycle or lawn mower.

In another example, the vehicle fluid delivery system is used to supply a fluid, for example lubricant and/or fuel, to a hand tool, for example a hedge trimmer or leaf blower.

The fluid may comprise for example an aqueous or other solvent-based composition, for example a cleaning composition. The fluid may for example comprise windscreen wash fluid. A fluid delivery system of an example of an aspect of the present disclosure may be for supplying fluid to the windscreen washer fluid delivery system for example of a vehicle. Other examples are possible as well.

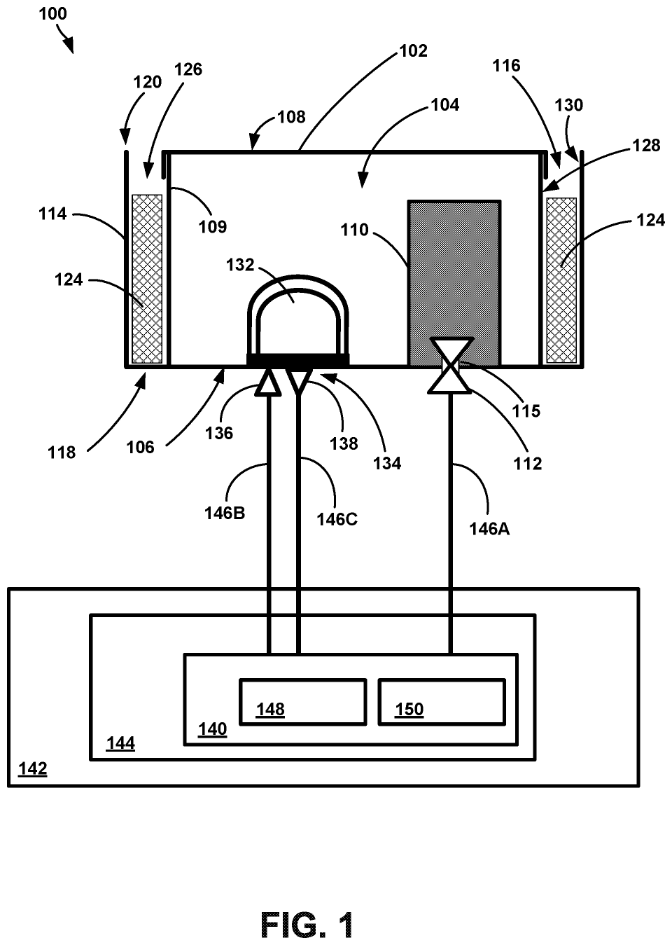

With reference to the Figures, FIG. 1 illustrates a vehicle fluid delivery system 100 according to an example embodiment. As shown in FIG. 1, the vehicle fluid delivery system 100 includes a housing 102 defining a first cavity 104. The housing 102 includes a first side 106 and a second side 108 opposite the first side 106. The first side 106 and the second side 108 of the housing 102 are separated by a continuous side wall 109 extending around their peripheries. The housing 102 is adapted to be removable from a vehicle 142. The vehicle fluid delivery system 100 also includes a fluid reservoir 110 positioned in the first cavity 104 of the housing 102. In one example, the fluid reservoir 110 is removably positioned in the first cavity 104 such that the entire fluid reservoir 110 can be replaced when a fluid positioned therein needs replacing. In another example, the fluid reservoir 110 is permanently positioned in the first cavity 104, and a fluid positioned therein can be removed and replaced while leaving the fluid reservoir 110 in place. The fluid reservoir 110 may comprise an inflexible bladder, a flexible bladder, or other fluid containment structure.

As shown in FIG. 1, the vehicle fluid delivery system 100 also includes a fluid port coupling 112 disposed on the first side 106 of the housing 102. The fluid port coupling 112 provides fluid access to the fluid reservoir 110. The vehicle fluid delivery system 100 also includes a fluid barrier 114 external to and contiguous with the side wall 109 of the housing 102. In one example, the fluid barrier 114 includes a through-hole 115 through which the fluid port 112 coupling is disposed. The fluid barrier 114 may form a second cavity 116 in which the housing 102 is at least partially positioned, as shown in FIG. 1. As such, and as shown in FIG. 1, a second cavity 116 of the fluid barrier 114 is nearly completely filled by the housing 102 when the housing 102 is positioned therein.

In one example, the housing 102 has a first thickness, and the fluid barrier 114 has a second thickness that is less than the first thickness. In one particular example, the first thickness of the housing 102 is at least twice as great as the second thickness of the fluid barrier 114.

In one example, the housing 102 comprises a first material, and the fluid barrier 114 comprises a second material that is different than the first material. In one example, the first material of the housing 102 comprises a flexible glass fibre bonded with a flexible epoxy, and the second material of the fluid barrier 114 comprises a ductile elastomer. In one particular example, the second material of the fluid barrier 114 comprises DuPont™ Hytrel®. Other materials are possible as well. In one example, the second material forming the fluid barrier 114 has a lower elastic modulus than the first material of the housing 102. In another example, the second material forming the fluid barrier 114 has a higher fracture toughness than the first material of the housing 102. In yet another example, the second material forming the fluid barrier 114 has a higher strain value at its yield point on a stress-strain curve than the first material of the housing 102. The second material of the fluid barrier 114 comprises a material with high strength, high flexibility, high elasticity, high temperature performance (e.g., −40° C. to +140° C.), and/or high ductile properties with tolerance for high levels of strain before failure.

The material properties of the fluid barrier 114 provide a secondary containment component that either partially or fully encapsulates the housing 102. As such, in one example the fluid barrier 114 is a shield. In particular, the fluid barrier 114 acts as a shield or barrier against uncontrolled fluid release in the event that the fluid reservoir 110 in the housing 102 ruptures or otherwise fails to contain the fluid in the fluid reservoir 110. The fluid barrier 114 is a non-load bearing flexible part that is designed to withstand high strain rates before tearing or rupture. In contrast, the housing 102 may be load bearing and more rigid than the fluid barrier 114. In addition, the positioning of the fluid barrier 114 around the perimeter of the housing 102 helps ensure that while under conditions of extreme encroachment and crushing (e.g., a collision of the vehicle) the fluid reservoir 110 positioned in the housing 102 may break, splashing of the liquid in the fluid reservoir 110 is mitigated by the presence of the fluid barrier 114.

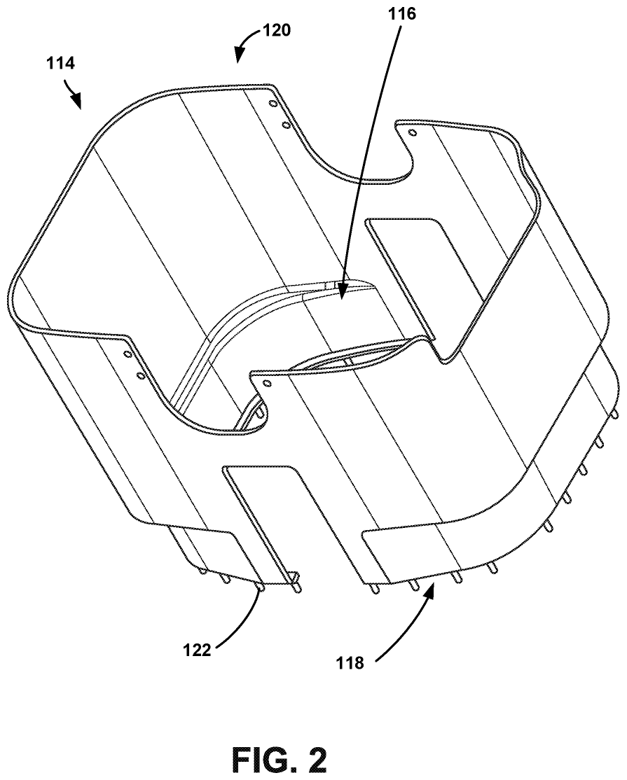

In one example, the fluid barrier 114 extends across the first side 106 of the housing 102. In another example, the fluid barrier 114 extends between the first side 106 and the second side 108 of the housing 102. A perspective view of an example fluid barrier 114 is shown in FIG. 2. As shown in FIG. 2, the fluid barrier 114 includes a first side 118 and a second side 120. The first side 118 of the fluid barrier 114 may be open such that it does not extend across the first side 106 of the housing 102. Further, the first side 118 of the fluid barrier 114 may include a plurality of pins 122 that are configured to interact with a corresponding plurality of holes in a structure in the vehicle on which the fluid barrier 114 is positioned when in use.

In one example, as shown in FIG. 1, the vehicle fluid delivery system 100 further comprises an absorbent material 124 positioned in a gap 126 between an outer surface 128 of the housing 102 and an inner surface 130 of the fluid barrier 114. In one example, the absorbent material 124 comprises a fire retardant flexible foam, a flexible foam, a fibrous matting, and/or an open-cell foam having a seal adjacent the inner surface 130 of the fluid barrier 114. The absorbent material 124 helps improve the fluid retention of fluid barrier 114 during conditions of extreme encroachment and crushing of the housing 102. In addition, the absorbent material 124 helps to dampen the velocity of any escaping fluid, and delay the fluid release until a time after the impact or collision when motion of the vehicle has finished.

Although the embodiment described above positions the absorbent material 124 between the housing 102 and the fluid barrier 114, it may be possible to couple the absorbent material 124 to the housing 102 without the presence of the fluid barrier 114 at all. In such an example, the absorbent material 124 alone acts as a barrier against uncontrolled fluid release in the event that the fluid reservoir 110 in the housing 102 including becomes ruptured. In another example, the material forming the fluid barrier 114 comprises the absorbent material 124, such as a fire retardant flexible foam, a flexible foam, a fibrous matting, and/or an open-cell foam, as discussed above.

In yet another example, the inner surface 130 of the fluid barrier 114 comprises a flexible glass fibre bonded with a flexible epoxy. Such an arrangement may retain porosity and hence absorption properties, and therefore may provide similar benefits to the absorbent material 124 described above.

In at least some examples the fluid reservoir 110 of the vehicle fluid delivery system 100 contains a fluid positioned therein, for example a liquid. The liquid may be lubricating oil composition, for example an engine lubricating oil composition, a gear oil, or heat exchange fluid for an electric engine. The liquid may be a liquid for a self-sustaining fluid system such as a lubricating oil composition for an engine lubricating oil composition, or a heat exchange fluid for a heat exchange fluid for an electric engine. The liquid may be a liquid for a non-sustaining fluid system, for example de-icer, water and or detergent.

Thus, the vehicle fluid delivery system 100 may be provided as a self-contained system containing fresh, refreshed or unused engine lubricating oil composition which may conveniently replace a vehicle fluid delivery system 100 on an engine which comprises a fluid reservoir 110 containing used or spent engine lubricating oil composition. If the vehicle fluid delivery system 100 also comprises an oil filter 132, this also is replaced together with the spent or used heat exchange fluid. The lubricating oil composition may have heat exchange properties.

The lubricating oil composition may comprise at least one base stock and at least one lubricating oil additive. Suitable base stocks include bio-derived base stocks, mineral oil derived base stocks, synthetic base stocks and semi synthetic base stocks. Suitable lubricating oil additives, for example engine lubricating oil additives are known in the art. Examples of additives include organic and/or inorganic compounds. Typically, according to at least some examples, the engine lubricating oil composition comprises about 60% to 90% by weight in total of base stocks and about 40% to 10% by weight additives. Suitable engine lubricating oil compositions include lubricating oil compositions for internal combustion engines.

The lubricating oil composition may be a mono-viscosity grade or a multi-viscosity grade engine lubricating oil composition. Examples of suitable engine lubricating oil compositions include single purpose lubricating oil compositions and multi-purpose lubricating oil compositions.

According to at least some examples, the lubricating oil composition is a lubricating oil composition for example and engine lubricating oil composition for example for an internal combustion engine, for example a spark ignition internal combustion engine and/or a compression internal combustion engine.

The liquid may be a heat exchange fluid for an electric engine. Thus, the vehicle fluid delivery system 100 may be provided as a self-contained system containing fresh, refreshed or unused heat exchange fluid for an electric engine which may conveniently replace a container on an engine which container comprises a reservoir containing used or spent heat exchange fluid. If the vehicle fluid delivery system 100 also comprises an oil filter 132, this also is replaced together with the spent or used heat exchange fluid.

Suitable heat exchange fluids for electric engines include aqueous and nonaqueous fluids. Suitable heat exchange fluids for electric engines include those which comprise organic and/or non-organic performance boosting additives.

Suitable heat exchange fluids include be man-made or bio-derived fluids, for example Betaine. According to at least some embodiments, the heat exchange fluids have fire retarding characteristics and/or hydraulic characteristics. Suitable heat exchange fluids include phase change fluids. Suitable heat exchange fluids include molten metals and salts. Suitable heat exchange fluids may include nanofluids. Nanofluids comprise nanoparticles suspended in a base fluid, which may be solid, liquid or gas. Suitable heat exchange fluids may include both gases and liquids. Suitable heat exchange fluids may further include liquefied gases.

While vehicle fluid systems for example vehicle engine fluid systems have been described herein, the present invention also relates to fluid systems for engines in general whether or not associated with a vehicle.

The vehicle fluid delivery system 100 may further comprise an oil filter 132 disposed in the first cavity 104 of the housing 102. In such an example, the vehicle fluid delivery system 100 also includes a second fluid port coupling 134 disposed on the first side 106 of the housing 102. As shown in FIG. 1, the second fluid port coupling 134 includes an inlet 136 to the oil filter 132 and an outlet 138. In the context of the present disclosure, any of the fluid port couplings 112, 134 described herein could comprise any suitable coupling for retaining the housing 102 in fluid communication with a corresponding fluid system 140, as shown in FIG. 1. The fluid port couplings 112, 134 could be arranged to be remotely decoupled from the fluid lines. Further, the fluid reservoir 110 and/or the housing 102 could comprise an actuator to decouple the fluid reservoir 110 from the fluid system 140. The fluid port couplings 112, 134 described herein may comprise a self-sealing port. In general, self-sealing ports have the characteristic that when corresponding ports are being connected, a seal is made between the connecting ports before valve or valves open to allow fluid to flow. On disconnection, the valve or valves close to seal off each of the ports before the seal between the ports is broken. Suitable valves include spring loaded poppet valves and biased non-return valves. Each self-sealing port of the vehicle fluid delivery system 100 may provide a “dry break” in which no fluid flows on connection or disconnection of the ports. Alternatively, each self-sealing port of the system may provide a “damp break” in which there is flow of only a non-essential amount of fluid, for example a few drips of liquid, on disconnection or connection of the port. In some examples, the fluid port couplings 112, 134 comprise a non-return valve. In preferred embodiments, the oil filter 132 comprises non-return valves on the inlet 136 and outlet 138 of the second fluid port coupling 134. Other examples are possible as well.

In one embodiment, as shown in FIG. 1, the present disclosure provides the vehicle 142 comprising the vehicle fluid delivery system 100 of any of the embodiments described above, and a fluid system 140 of the vehicle 142 in fluid communication with the housing 102. In such an embodiment, the fluid system 140 may be a lubricant circulation system that delivers a lubricating oil to an engine 144 of the vehicle 142 via one or more fluid lines 146A-146C. As discussed above, the fluid system 140 of the vehicle 142 may also include a controller 148 to control operation of one or more of the fluid port couplings 112, 134, for example to control the rate or amount of fluid provided to and from the fluid system 140. This may be done by controlling a transfer pump 150 located between the housing 102 and the engine 144. Alternatively, the engine pump (which may be a mechanical or an electrical pump) may be utilized for fluid transfer.

In another embodiment, the present disclosure provides an apparatus comprising the vehicle fluid delivery system 100 of any of the embodiments described above, and a fluid system 140 of the apparatus in fluid communication with the housing 102. In such an embodiment, the fluid system 140 may be a lubricant circulation system that delivers a lubricating oil to an engine 144 of the apparatus. As such, the vehicle 142 shown in FIG. 1 could be replaced with an apparatus having a similar arrangement of components.

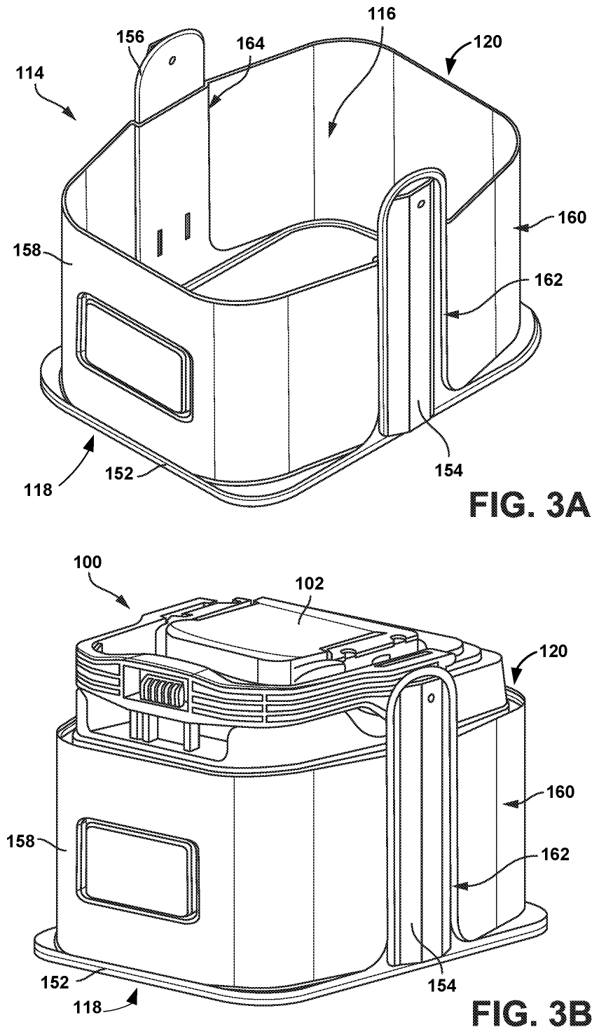

In one example embodiment, as shown in FIGS. 3A-3B, the fluid barrier 114 includes a base plate 152 positioned at the first side 118 of the fluid barrier 114. The base plate 152 may include a through-hole through which the fluid port coupling 112 is disposed. The fluid barrier 114 further includes a first support 154 extending vertically from the base plate 152, a second support 156 extending vertically from the base plate 152, and a side wall 158 extending vertically from the base plate 152. As shown in FIG. 3B, the side wall 158 defines the second cavity 116 of the fluid barrier 114, into which the housing 102 may be positioned.

The base plate 152, the first support 154, and the second support 156 may comprise a first material, and the side wall 158 of the fluid barrier 114 comprises a second material that is different than the first material. In one example, the first material comprises steel, and the second material comprises a polyester elastomer. In one particular example, the side wall 158 of the fluid barrier 114 comprises DuPont™ Hytrel®. As discussed above, the second material of the side wall 158 of the fluid barrier 114 comprises a material with high strength, high flexibility, high elasticity, high temperature performance, and/or high ductile properties with tolerance for high levels of strain before failure.

In one example, the base plate 152, the first support 154, and the second support 156 may comprise a single integral component, and the side wall 158 of the fluid barrier 114 may be removably or permanently coupled to that single integral component. In another example, the base plate 152 is formed separate from the first support 154 and the second support 156, and are joined together later in the manufacturing process.

An outer surface 160 of the side wall 158 of the fluid barrier 114 may include a first channel 162 configured to receive the first support 154, and the outer surface 160 of the side wall 158 may further include a second channel 164 configured to receive the second support 156. The first and second channels 162, 164 may prevent rotation of the side wall 158 with respect to the base plate 152 when the first support 154 is positioned in the first channel 162 and the second support 156 is positioned in the second channel 164.

In one example, the base plate 152, the first support 154, and the second support 156 have a first thickness, and the side wall 158 of the fluid barrier 114 has a second thickness that is less than the first thickness.

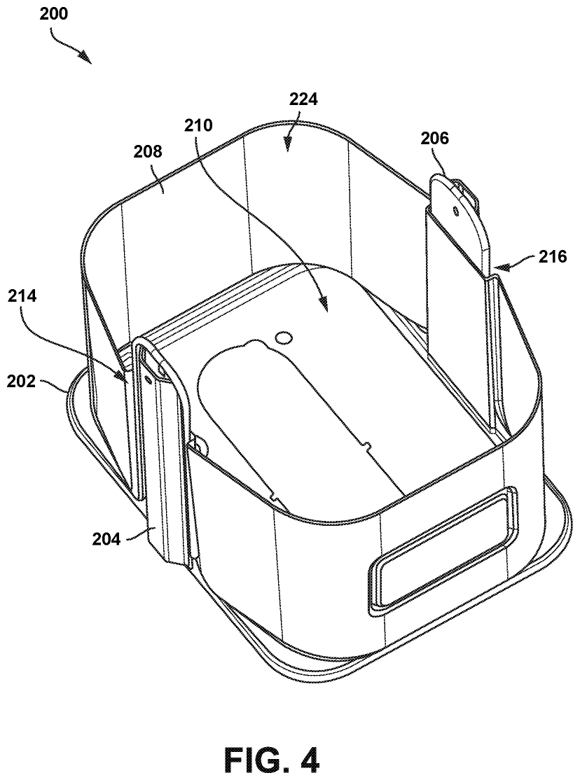

In yet another embodiment, the present disclosure provides a device 200, as shown in FIG. 4. The device 200 shown in FIG. 4 may be similarly configured as the fluid barrier 114 as shown and described in relation to FIG. 3A. In particular, the device 200 includes a base plate 202, a first support 204 extending vertically from the base plate 202, a second support 206 extending vertically from the base plate 202, and a side wall 208 extending vertically from the base plate 202. As shown in FIG. 4, the side wall 208 defines a cavity 210.

In one example, the base plate 202, the first support 204, and the second support 206 comprise a first material, and the side wall 208 comprises a second material that is different than the first material. The first material may comprise steel, and the second material may comprise a polyester elastomer. In one particular example, the side wall 208 comprises DuPont™ Hytrel®. The second material of the side wall 208 comprises a material with high strength, high flexibility, high elasticity, high temperature performance, and high ductile properties with tolerance for high levels of strain before failure.

The side wall 208 is a non-load bearing flexible part that is designed to withstand high strain rates before tearing or rupture. In use, a housing including a fluid reservoir is configured to be positioned in the cavity 210 of the side wall 208 such that the side wall 208 either partially or fully encapsulates the housing. The positioning of the side wall 208 around the perimeter of the housing helps ensure that while under conditions of extreme encroachment and crushing the fluid reservoir positioned in the housing may break, splashing of the fluid may be mitigated by the presence of the side wall 208. As such, the side wall 208 acts as a barrier against uncontrolled fluid release in the event that the fluid reservoir in the housing including becomes ruptured.

In one example, the base plate 202, the first support 204, and the second support 206 may comprise a single integral component, and the side wall 208 may be removably or permanently coupled to that single integral component. In another example, the base plate 202 is formed separate from the first support 204 and the second support 206, and are joined together later in the manufacturing process.

As shown in FIG. 4, an outer surface 212 of the side wall 208 includes a first channel 214 configured to receive the first support 204, and the outer surface 212 of the side wall 208 includes a second channel 216 configured to receive the second support 206. The first and second channels 214, 216 may prevent rotation of the side wall 208 with respect to the base plate 202 when the first support 204 is positioned in the first channel 214 and the second support 206 is positioned in the second channel 216.

In one example, the base plate 202, the first support 204, and the second support 206 have a first thickness, and the side wall 208 has a second thickness that is less than the first thickness.

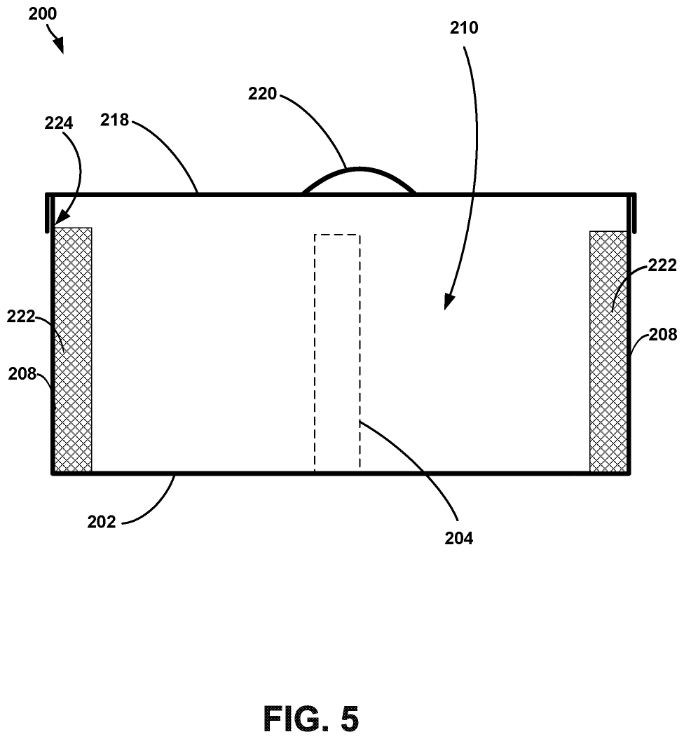

As shown in FIG. 5, the device 200 may further include a removable top 218 removably coupled to the side wall 208. The removable top 218 may be removably coupled to the side wall 208 in a variety of ways, such as press fit, latches, bolts, clips, or any other temporary coupling mechanism. In another example, as shown in FIG. 5, the removable top 218 includes a handle 220. The handle 220 may be recessed with respect to the removable top 218, or may be foldable or rotatable out of the plane of the removable top 218 and may be used to easily grasp the device 200 to thereby transport the device 200 and/or to remove the removable top 218 from the device 200.

In yet another example, as shown in FIG. 5, the device 200 may further include an absorbent material 222 coupled to an inner surface 224 of the side wall 208. In one example, the absorbent material 222 comprises a fire retardant flexible foam, a flexible foam, a fibrous matting, and/or an open-cell foam. The absorbent material 222 helps improve the fluid retention of device 200 during conditions of extreme encroachment and crushing of a housing positioned in the cavity 210 of the side wall 208 of the device 200. In addition, the absorbent material 222 may help to dampen the velocity of any escaping fluid, and delay the fluid release until a time after the impact or collision when motion of the vehicle has finished. In another example, the inner surface 224 of the side wall 208 comprises flexible glass fibre bonded with a flexible epoxy. Such an arrangement may retain porosity and hence absorption properties, and therefore may provide similar benefits to the absorbent material 222 described above.

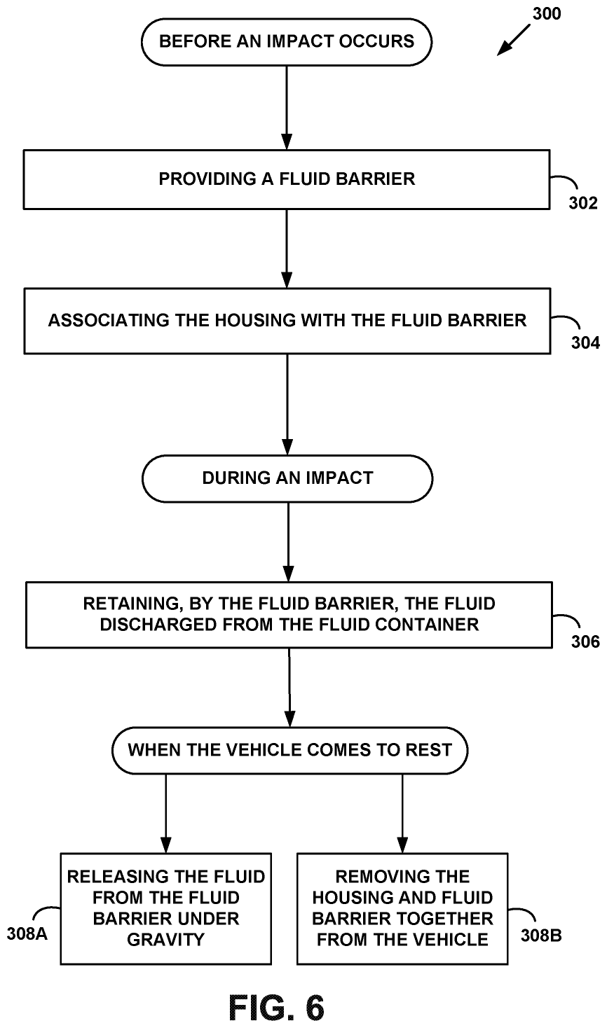

FIG. 6 is a simplified flow chart illustrating a method 300 of retaining a fluid discharged from the vehicle fluid delivery system as described above in relation to FIGS. 1-5 during an impact. Although the blocks in FIG. 6 are illustrated in a sequential order, these blocks may also be performed in parallel, and/or in a different order than those described herein. Also, the various blocks may be combined into fewer blocks, divided into additional blocks, and/or removed based upon the desired implementation.

At block 302, the method 300 includes, before an impact occurs, providing a fluid barrier 114. At block 304, the method 300 further includes associating the housing 102 with the fluid barrier 114. In one example, associating the housing 102 with the fluid barrier 114 comprises positioning the housing 102 in a second cavity 116 defined by the fluid barrier 114. At block 306, the method 300 includes, during an impact, retaining, by the fluid barrier 114, the fluid discharged from the fluid reservoir 110. As such, the positioning of the fluid barrier 114 around the perimeter of the housing 102 helps ensure that while under conditions of extreme encroachment and crushing (e.g., an impact of the vehicle) the fluid reservoir 110 positioned in the housing 102 may break, splashing of the liquid in the fluid reservoir 110 is mitigated by the presence of the fluid barrier 114.

At block 308A, the method 300 further includes, when the vehicle comes to rest, releasing the fluid from the fluid barrier 114 under gravity. At block 308B, the method 300 further includes, when the vehicle comes to rest, removing the housing 102 and fluid barrier 114 together from the vehicle. Method steps 308A and 308B may be performed alternatively or in combination such that just method step 308A is performed (and not method step 308B), just method step 308B is performed (and not method step 308A), or both method steps 308A and 308B are performed.

The above detailed description describes various features and functions of the disclosed systems, devices, and methods with reference to the accompanying Figures. In the Figures, similar symbols typically identify similar components, unless context dictates otherwise. The illustrative embodiments described in the detailed description, Figures, and claims are not meant to be limiting. Other embodiments can be utilized, and other changes can be made, without departing from the scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A vehicle fluid delivery system comprising:
a housing defining a first cavity, wherein the housing includes a first side and a second side opposite the first side, the first side and the second side being separated by a continuous side wall extending around their peripheries, and wherein the housing is adapted to be removable from a vehicle;
a fluid reservoir positioned in the first cavity of the housing;
a fluid port coupling disposed on the first side of the housing and providing fluid access to the fluid reservoir; and
a fluid barrier external to and contiguous with the side wall.

2. The vehicle fluid system of claim 1, wherein the fluid barrier extends across the first side of the housing.

3. The vehicle fluid system of claim 2, wherein the fluid barrier extends between the first side and the second side of the housing.

4. The vehicle fluid system of claim 2, wherein the fluid barrier forms a second cavity in which the housing is positioned.

5. The vehicle fluid system of claim 1, wherein the fluid barrier is a shield.

6. The vehicle fluid system of claim 6, wherein the shield has a thickness in the range 0.75 mm to 1.5 mm.

7. The vehicle fluid delivery system of claim 1, wherein the fluid barrier comprises a ductile elastomer.

8. The vehicle fluid delivery system of claim 1, wherein the material forming the fluid barrier has a lower elastic modulus than the housing.

9. The vehicle fluid delivery system of claim 1, wherein the material forming the fluid barrier has a higher fracture toughness than the housing.

10. The vehicle fluid delivery system of claim 1, wherein the material forming the fluid barrier has a higher strain value at its yield point on a stress-strain curve than the housing.

11. The vehicle fluid delivery system of claim 1, wherein the housing is load-bearing and the fluid barrier is non-load-bearing.

12. The vehicle fluid delivery system of claim 1, wherein the housing comprises a flexible glass fibre bonded with a flexible epoxy.

13. The vehicle fluid delivery system of claim 1, wherein the fluid barrier comprises an absorbent material.

14. The vehicle fluid delivery system of claim 1, wherein the fluid barrier further comprises:
an absorbent material positioned in a gap between an outer surface of the housing and an inner surface of the fluid barrier.

15. The vehicle fluid delivery system of claim 13, wherein the absorbent material comprises a flexible foam or a fibrous matting.

16. The vehicle fluid delivery system of claim 13, wherein the absorbent material comprises an open-cell foam having a seal adjacent the inner surface of the fluid barrier.

17. The vehicle fluid delivery system of claim 1, further comprising:
an oil filter disposed in the first cavity of the housing; and
a second fluid port coupling disposed on the first side of the housing, wherein the second fluid port coupling includes an inlet to the oil filter and an outlet.

18. The vehicle fluid delivery system of claim 1, wherein the fluid barrier includes a through-hole through which the fluid port coupling is disposed.

19. The vehicle fluid delivery system of claim 1, wherein the fluid reservoir includes a fluid positioned therein, and where the fluid comprises an engine oil, a gear oil or a heat exchange fluid for an electric motor.

20. A vehicle comprising:
the vehicle fluid delivery system of claim 1; and
a fluid system of the vehicle in fluid communication with the housing.

21. The vehicle of claim 20, wherein the fluid system delivers a lubricating oil to an engine of the vehicle.

22. An apparatus comprising:
the vehicle fluid delivery system of claim 1; and
a fluid system of the apparatus in fluid communication with the housing.

23. A method of retaining a fluid discharged from the vehicle fluid delivery system as claimed in claim 1 during an impact, the method comprising:
before an impact occurs, (i) providing a fluid barrier, and (ii) associating the housing with the fluid barrier; and
during an impact, retaining, by the fluid barrier, the fluid discharged from the fluid reservoir.

24. The method as claimed in claim 23, further comprising the step of:
when the vehicle comes to rest, releasing the fluid from the fluid barrier under gravity.

25. The method as claimed in claim 23, further comprising the step of:
when the vehicle comes to rest, removing the housing and fluid barrier together from the vehicle.
